(19) United States
(12) Patent Application Publication
(10) Pub. No.: US 2024/0219256 A1
(43) Pub. Date: Jul. 4, 2024

(54) MOISTURE DETECTOR CONFIGURED TO DETECT MOISTURE IN A CABLE

(71) Applicant: PPC BROADBAND, INC., East Syracuse, NY (US)

(72) Inventors: Roger MATHEWS, Syracuse, NY (US); Raymond PALINKAS, East Syracuse, NY (US); David BARANY, Syracuse, NY (US); Thomas HART, Fayetteville, NY (US)

(73) Assignee: PPC BROADBAND, INC., East Syracuse, NY (US)

(21) Appl. No.: 18/399,920

(22) Filed: Dec. 29, 2023

Related U.S. Application Data
(60) Provisional application No. 63/436,315, filed on Dec. 30, 2022.

(51) Int. Cl. G01M 3/04

(52) U.S. Cl. CPC G01M 3/045; H01B 11/18

(57) ABSTRACT

A moisture detector detects moisture in a coaxial cable. The moisture detector may include a moisture detection portion disposed in at least a portion of a cavity portion and configured to engage a cable moisture alert portion that is configured to generate a cable moisture alert when moisture is present in the cavity portion, and wherein the moisture detection portion is configured to generate a moisture detected signal when moisture is present in the cavity portion and cause the cable moisture alert portion to generate the cable moisture alert that moisture is present in the coaxial cable when moisture is present in the cavity portion.

### CROSS-REFERENCE TO RELATED APPLICATION

This application claims priority from U.S. Provisional Application No. 63/436,315 filed Dec. 30, 2022, which is currently pending, the disclosure of which is hereby incorporated by reference herein in its entirety.

### TECHNICAL FIELD

The present invention relates generally a moisture detector configured to detect moisture in a cable. More particularly, the present invention relates to a moisture detector configured to detect moisture in a coaxial cable connected to the moisture detector.

### BACKGROUND

Cables used to connect to a customer premises may be exposed to environmental conditions. For example, a cable company may use a coaxial drop cable to connect services to a customer premises. Such a cable may be connected from a pole to a customer premises or be buried underground. Such cables typically have a center conduct encased by an insulation layer surrounded by a metal braid and an outer jacket. A problem that may occur with such a cable is that it may be exposed to moisture such as water such as when the outer jacket is compromised or for other reasons. Such exposure may result in damage to the cable and/or loss of service.

This loss of service may occur slowly over time due to the water degrading the signal passing through the cable in the bandwidth of operation of the signal. The degradation may not be uniform or predictable and may be caused by the moisture or water corroding elements of the cable over time.

It may be desirable to provide a device that can detect exposure to moisture or water in such a cable so that corrective action can be arranged before such a loss in service or failure of the cable occurs. Additionally, it would be beneficial if a service provider could detect such a potential problem before a failure or loss of service occurs so that corrective action can be arranged.

### SUMMARY

In accordance with various embodiments of the present disclosure, a moisture detector is configured to detect moisture in a coaxial cable. The moisture detector may include a housing portion configured to mechanically couple with a coaxial cable connector that terminates a coaxial cable, an inner conductor portion disposed in at least a portion of a housing cavity portion of the housing portion and structurally configured to pass a radio frequency (RF) signal through the housing portion to a moisture alert device that is configured to provide a moisture presence alert when moisture is detected in the housing cavity portion, a moisture detection circuit disposed in at least a portion of the housing cavity portion, wherein the housing portion comprises an outer conductor portion that is configured to at least partially surround the inner conductor portion, wherein the housing portion includes a connection portion that is configured to at least partially receive a coaxial cable connector that terminates the coaxial cable, wherein the connection portion is configured to electrically couple an outer conductor of the coaxial cable connector with the outer conductor portion and to electrically couple a center conductor of the coaxial cable with the inner conductor portion, and wherein the moisture detection circuit comprises an RF circuit that is configured to change an RF signal value when moisture is present in the housing cavity portion and relay an electronic signal to the moisture alert device so as to provide the moisture presence alert that moisture is present in the coaxial cable when moisture is detected in the housing cavity portion.

A moisture detector is configured to detect moisture in a coaxial cable. The moisture detector may include a housing portion having a housing cavity portion and configured to couple with a coaxial cable connector that is configured to terminate a coaxial cable, an inner conductor portion disposed in at least a portion of the housing cavity portion and configured to pass a moisture detection signal through the housing portion to a moisture presence alert portion that is configured to generate a moisture presence alert, a moisture detection portion configured to be disposed in at least a portion of the housing cavity portion, and wherein the moisture detection portion comprises an circuit configured to change a signal value when moisture is present in the housing cavity portion so as to generate a moisture detected signal and cause the moisture alert portion to generate a moisture present alert that moisture is present in the coaxial cable when moisture is detected in the housing cavity portion.

A moisture detector detects moisture in a coaxial cable. The moisture detector may include a moisture detection portion disposed in at least a portion of a cavity portion and configured to engage a cable moisture alert portion that is configured to generate a cable moisture alert when moisture is present in the cavity portion, and wherein the moisture detection portion is configured to generate a moisture detected signal when moisture is present in the cavity portion and cause the cable moisture alert portion to generate the cable moisture alert that moisture is present in the coaxial cable when moisture is present in the cavity portion.

Various aspects of the device, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a schematic view of a moisture detector in accordance with disclosed aspects.

FIG. 2 is a schematic view of the moisture detector of FIG. 1 with moisture in the cavity in accordance with disclosed aspects.

FIG. 3 is a schematic view of a moisture detector in accordance with an alternate embodiment of disclosed aspects.

FIG. 4 is a schematic view of a moisture detector in accordance with an alternate embodiment of disclosed aspects.

FIG. 5 is a schematic view of a moisture detector in accordance with an alternate embodiment of disclosed aspects.

### DETAILED DESCRIPTION OF EMBODIMENTS

Embodiments of the disclosure provide a moisture detector configured to detect moisture in a cable. By detecting moisture in the cable before the cable is degraded by the moisture, corrective action can be arranged before a loss in service or failure of the cable occurs.

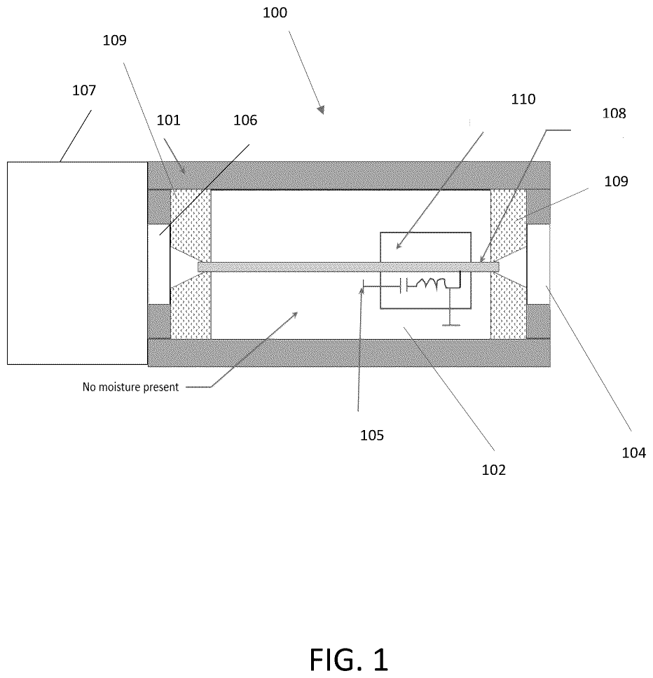

Referring first to FIG. 1, a moisture detector or detection device 100 configured to detect moisture in a cable is depicted. The moisture detector 100 is configured to detect moisture in a cable such as a coaxial cable that the moisture detector 100 is connected to, and to generate a signal indicating that moisture has been detected, such as a moisture detection signal. In some embodiments, the moisture detection signal may be an RF or other electrical signal. The signal that moisture has been detected can be used to allow repairs to the cable (such as by replacing the cable and/or determining a condition that caused the moisture in the cable) preferably before the moisture in the cable causes a failure to the cable or enough degradation to the cable that may cause loss or degradation of service. For example, a service provider can detect or be provided with the signal that moisture has been detected, as further described herein, and send a technician to address the problem.

In some embodiments, the moisture detector 100 may include housing portion 101, a cavity 102, an outer conductor portion or outer conductor 103, a center conductor portion or center conductor 108, connector portions 104, 106, and a moisture detection circuit 110 within the cavity 102. The outer conductor portion 103 may comprise, for example, a conductive material, such as a metallic material. The center conductor portion 108 may comprise, for example, a conductive material, such as a metallic material. The connection portion 104, 106 may comprise, for example, a connector configured to connect to a coaxial cable. The connector may include a threaded portion configured to receive a threaded connector of a coaxial cable or any other type of connector configured to connect with a coaxial cable.

The center conductor portion 108 may be configured to connect with a center conductor of the coaxial cable that it is connected with. The center conductor portion 108 may be configured to convey any signal from the coaxial cable it is connected to along the center conductor 108. The center conductor may be held in place within the cavity by a holding portion 109, which may be a dielectric or other suitable material.

In some embodiments, the detection circuit may be connected to the center conductor 108. At least one of the connectors 104, 106 may be structurally configured to be connected to a coaxial cable 107 to be monitored for the presence of moisture. Moisture such as water in the coaxial cable 107 to be monitored for the presence of moisture may be transferred into the moisture detector 100 through one of the connectors 104, 106 that the coaxial cable 107 to be monitored is connected to, and is detected by the moisture detector 100, as further described herein. When no moisture is present, the moisture detection circuit 110 is inactive and a no moisture detected signal may be generated.

The moisture detection circuit 110 in some embodiments may be an RF circuit that includes a capacitor and an inductor that is connected to the center conductor 108 of moisture detector 100. The moisture detection circuit 110 may be configured with one or more contacts 105 in the cavity 102. When water or other moisture comes into contact with the contacts 105 of the moisture detection circuit 110, signal or RF values of the moisture detection circuit 110 are altered. The change or alteration in the signal or RF values is a moisture detection signal that is generated by the moisture detector 100.

The alteration of the RF or signal values produced by the moisture detection circuit 110 may be configured to be detectable by a device connected to the moisture detection device 100. For example, the moisture detection device 100 may be connected to a DOCSIS (Data Over Cable Service Interface Specification) enabled device (not shown). The DOCSIS enabled device may be programmed to monitor for any changes in the signal produced by the moisture detector 100. For example, the moisture detector 100 may be connected to a DOCSIS enabled device, such as a set top box, a modem, a headend, etc. that can be programmed to monitor for any changes in the signal produced by the moisture detector 100. In some embodiments, a predetermined level of change in the signal produced by the moisture detector 100 may be programmed in the DOCSIS enabled device to indicate a moisture detected condition with the cable 107. In this way, the moisture condition of the coaxial cable 107 may be monitored, and a moisture detected signal may be generated when moisture is detected by the moisture detector 100.

In some embodiments, the moisture detection circuit 110 may be other than the RF circuit illustrated in the figures. For example, a magnetic material could be used to detect moisture by measuring changes in a magnetic field in the cavity.

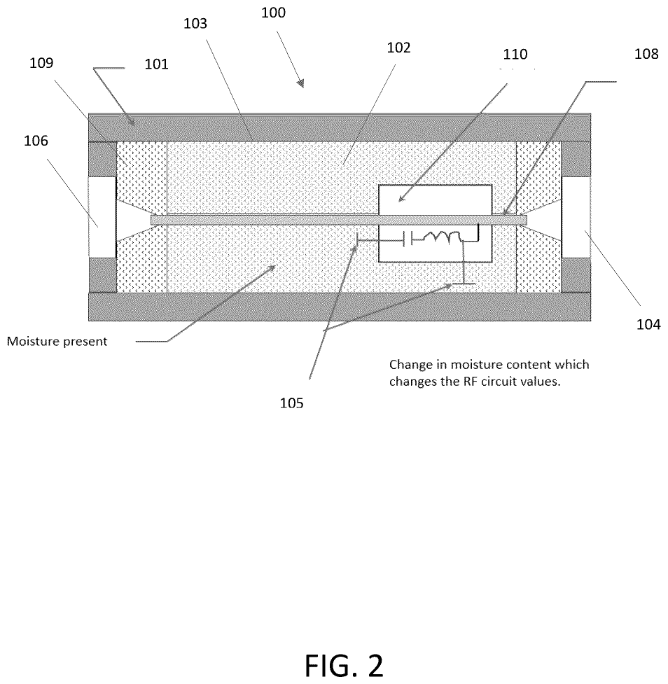

As illustrated in FIG. 2, when moisture such as water is within the cavity 102 of the moisture detector 100, and the moisture comes into contact with one or more of the contacts 105 in cavity 102, the RF values of the moisture detector circuit 110 are altered. As explained above, this allows a programmed DOCSIS enabled device to detect the change and generate a moisture detected signal for the coaxial cable 107.

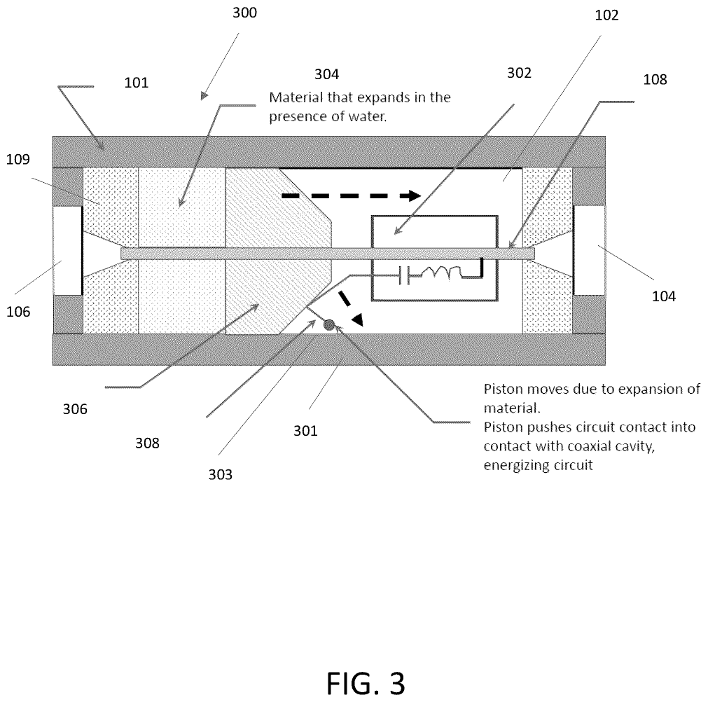

FIG. 3 illustrates an alternate embodiment of a moisture detector 300. The moisture detector 300 uses like reference numerals for like elements. The moisture detector 300 may include a moisture detection circuit such as RF or other circuit 302, a material 304 that expands in the presence of moisture or liquid (such as water) in cavity 102, housing 101, and a piston 306 in cavity 102 and in contact with the material 304 that expands in the presence of moisture or liquid. When moisture or liquid comes in contact with material 304, the material 304 expands and causes the piston 306 to move to the right in FIG. 3, eventually causing the circuit contact 308 to come into contact with the outer conductor 303, causing a change in the signal or RF values of the RF circuit 302. As described above, this change in RF or other signal values can be detected as a moisture detected signal for the coaxial cable 107. As previously described, a DOCSIS enabled device may be connected to the moisture detector 300 to detect the moisture detected signal.

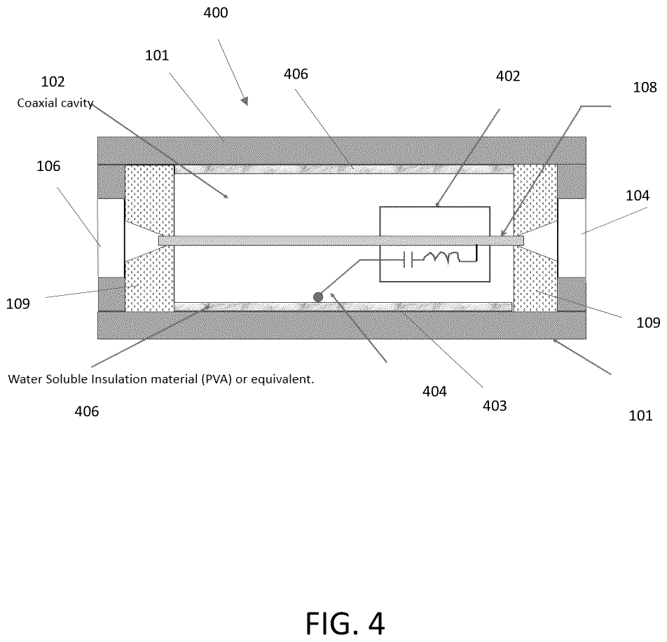

FIG. 4 illustrates an alternate embodiment of a moisture detector 400. The moisture detector 400 uses like reference numerals for like elements. The moisture detector 400 may include moisture detection circuit 402, one or more circuit contacts 404 and moisture, liquid and/or water-soluble material 406 on inner surfaces of the outer conductor 101. In some embodiments, the moisture, liquid or water-soluble material 406 may be a material such as PVA (poly vinyl alcohol) or an equivalent material, a biodegradable plastic material, although other moisture, liquid and/or water soluble materials could be used.

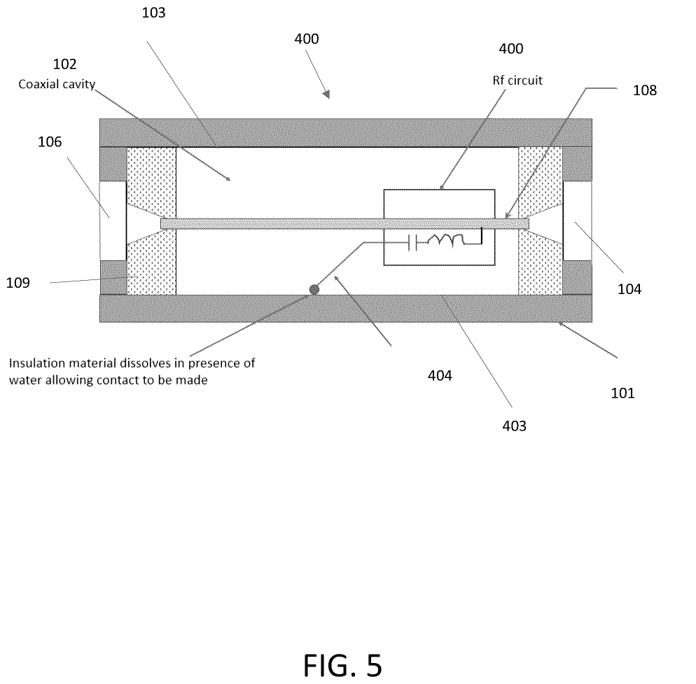

As illustrated in FIG. 5, when water or other moisture is present in the cavity 101, the moisture, liquid or water-soluble material 406 dissolves. This causes the circuit contact 404 to come into contact with the outer conductor 101, resulting in the RF or other signal values of moisture detection circuit 402 to change. As described above, this change in signal values can be detected as a moisture detected signal for the coaxial cable 107 being monitored. The change in the moisture detected signal can be detected by a device such as a DOCSIS enabled device connected to the moisture detector 400.

In some embodiments, the coaxial cable in which moisture is to be detected may be used in connection with a service provider, such as a cable TV and/or Internet service provider, where the coaxial cable is connected to a customer premises to deliver the service. For example, the coaxial cable may be connected from a pole to a ground block at a side of the customer premises to deliver the service. In some embodiments, the moisture detection device may be included within the ground block, with the coaxial cable connected to the moisture detection device of the ground block allowing detection of moisture in the coaxial cable. In some embodiment, the moisture detection device may be connected between the coaxial cable and the ground block.

Although the illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable moisture detector configured to detect moisture in a coaxial cable, comprising:
a housing portion configured to mechanically couple with a coaxial cable connector that terminates a coaxial cable;
an inner conductor portion disposed in at least a portion of a housing cavity portion of the housing portion and structurally configured to pass a radio frequency (RF) signal through the housing portion to a moisture alert device that is configured to provide a moisture presence alert when moisture is detected in the housing cavity portion;
a moisture detection circuit disposed in at least a portion of the housing cavity portion;
wherein the housing portion comprises an outer conductor portion that is configured to at least partially surround the inner conductor portion;
wherein the housing portion includes a connection portion that is configured to at least partially receive a coaxial cable connector that terminates the coaxial cable;
wherein the connection portion is configured to electrically couple an outer conductor of the coaxial cable connector with the outer conductor portion and to electrically couple a center conductor of the coaxial cable with the inner conductor portion; and
wherein the moisture detection circuit comprises an RF circuit that is configured to change an RF signal value when moisture is present in the housing cavity portion and relay an electronic signal to the moisture alert device so as to provide the moisture presence alert that moisture is present in the coaxial cable when moisture is detected in the housing cavity portion.

2. The cable moisture detector of claim 1, wherein the RF circuit comprises an inductor and a capacitor configured to be connected to the inner conductor portion and to generate the RF signal value.

3. The cable moisture detector of claim 1, further comprising a contact connected to the RF circuit, and wherein when the contact is contacted with moisture, the RF circuit value is changed.

4. The cable moisture detector of claim 1, further comprising a moisture expansion material disposed in the housing cavity portion, the moisture expansion material being configured to expand when in the presence of moisture, and a piston portion at least partially disposed in the housing cavity portion and connected to the RF circuit, wherein the piston portion is configured to move in at least a portion of the housing cavity portion when the moisture expansion material expands to cause the RF circuit to change the RF signal value.

5. The cable moisture detector of claim 1, further comprising a moisture-soluble material disposed on a portion of the outer conductor portion, and a contact portion configured to be connected to the RF circuit and to the moisture-soluble material, wherein the moisture-soluble material is configured to dissolve when moisture is present in the housing cavity portion so as to cause the contact portion to be contacted with the outer conductor portion to cause the RF circuit to change the RF signal value.

6. The cable moisture detector of claim 1, further comprising a holding portion disposed in at least a portion of the housing cavity portion and configured to hold the inner conductor in at least a portion of the housing cavity portion.

7. The cable moisture detector of claim 1, further comprising a moisture engaging portion configured to cause the RF circuit to change state when moisture is present in the housing cavity portion so as to cause the RF circuit to change the RF signal value.

8. A cable moisture detector configured to detect moisture in a coaxial cable, comprising:
a housing portion having a housing cavity portion and configured to couple with a coaxial cable connector that is configured to terminate a coaxial cable;
an inner conductor portion disposed in at least a portion of the housing cavity portion and configured to pass a moisture detection signal through the housing portion to a moisture presence alert portion that is configured to generate a moisture presence alert;
a moisture detection portion configured to be disposed in at least a portion of the housing cavity portion; and
wherein the moisture detection portion comprises an circuit configured to change a signal value when moisture is present in the housing cavity portion so as to generate a moisture detected signal and cause the moisture alert portion to generate a moisture present alert that moisture is present in the coaxial cable when moisture is detected in the housing cavity portion.

9. The cable moisture detector of claim 8, wherein the circuit configured to change a signal value when moisture is present in the housing cavity is an RF circuit.

10. The cable moisture detector of claim 8, wherein the housing portion comprises an outer conductor portion that is structurally configured to coaxially surround the inner conductor portion.

11. The cable moisture detector of claim 8, wherein the housing portion includes a connection portion that is structurally configured to receive a coaxial cable connector that terminates the coaxial cable.

12. The cable moisture detector of claim 8, wherein the connection portion is structurally configured to electrically couple an outer conductor of the coaxial cable connector with the outer conductor portion and to electrically couple a center conductor of the coaxial cable with the inner conductor portion.

13. The cable moisture detector of claim 8, wherein the moisture detection portion comprises a circuit that includes an inductor and a capacitor configured to be connected to an inner conductor and to generate the moisture detected signal.

14. The cable moisture detector of claim 8, wherein the moisture detection portion further comprises a moisture engagement portion that is configured to engage with the moisture detection portion, and wherein the moisture alert portion is configured to generate the moisture detected signal when moisture engages with the moisture engagement portion.

15. The cable moisture detector of claim 14, wherein the moisture engagement portion comprises a moisture contact portion that is configured to contact the moisture detection portion, and wherein the moisture alert portion is configured to generate the moisture detected signal when moisture contacts with the moisture contact portion.

16. The cable moisture detector of claim 8, wherein the moisture detection portion further comprises a moisture expansion material disposed in the housing cavity portion, the moisture expansion material being configured to expand when in the presence of moisture, and a piston portion disposed in at least a portion of the housing cavity portion and connected to the moisture detection portion, wherein the piston portion is configured to move in at least a portion of the housing cavity portion when the moisture expansion material expands to cause the moisture detection portion to change the moisture detected signal.

17. The moisture detector of claim 8, wherein the moisture detector further comprises a moisture-soluble material disposed on a surface of the outer conductor portion, and a contact configured to be connected to the moisture detection device and to the moisture-soluble material, wherein when moisture is present in the cavity, the moisture-soluble material is configured to dissolve to cause the contact to be contacted with the outer conductor portion to cause the moisture detection device to change the moisture detected signal.

18. The cable moisture detector of claim 8, further comprising a holding portion disposed in the housing cavity portion and configured to hold the inner conductor in position within at least a portion of the housing cavity portion.

19. A cable moisture detector configured to detect moisture in a coaxial cable, comprising:
a moisture detection portion disposed in at least a portion of a cavity portion and configured to engage a cable moisture alert portion that is configured to generate a cable moisture alert when moisture is present in the cavity portion; and
wherein the moisture detection portion is configured to generate a moisture detected signal when moisture is present in the cavity portion and cause the cable moisture alert portion to generate the cable moisture alert that moisture is present in the coaxial cable when moisture is present in the cavity portion.

20. The cable moisture detector of claim 19, further comprising a housing portion structurally configured to mechanically couple with a coaxial cable connector that terminates a coaxial cable.

21. The cable moisture detector of claim 19, further comprising an inner conductor portion disposed in a cavity of the housing portion and structurally configured to pass a moisture detection signal through the housing portion to an electronic component.

22. The cable moisture detector of claim 19, wherein the moisture detection portion comprises a moisture detection circuit.

23. The cable moisture detector of claim 19, wherein the housing portion comprises an outer conductor portion that is structurally configured to coaxially surround the inner conductor portion.

24. The cable moisture detector of claim 19, wherein the housing portion includes a connection portion that is structurally configured to receive a coaxial cable connector that terminates the coaxial cable.

25. The cable moisture detector of claim 19, wherein the connection portion is structurally configured to electrically couple an outer conductor of the coaxial cable connector with the outer conductor portion and to electrically couple a center conductor of the coaxial cable with the inner conductor portion.

26. The cable moisture detector of claim 19, wherein the moisture detection portion comprise a moisture detection circuit.

27. The cable moisture detector of claim 26, wherein the moisture detection circuit comprises an RF circuit.

28. The cable moisture detector of claim 26, wherein the moisture detection circuit comprises an inductor and a capacitor configured to be connected to an inner cable conductor portion and to generate a moisture detection signal.

29. The cable moisture detector of claim 26, wherein the moisture detection circuit is configured to change a generated circuit value when moisture is present in the cable cavity portion.

30. The cable moisture detector of claim 19, wherein the moisture detection portion comprises a moisture engagement portion that is configured to cause the moisture detection signal to be generated when moisture engages the moisture engagement portion.

31. The cable moisture detector of claim 19, wherein the moisture engagement portion comprises a moisture contact portion that is configured to cause the moisture detection signal to be generated when moisture contacts the moisture contact portion.

32. The cable moisture detector of claim 19, wherein the moisture detection portion comprises a moisture engagement portion disposed in at least a portion of the cavity portion and configured to change in size when moisture engages the moisture engagement portion so as to cause the moisture detection signal to generate the moisture detected signal when moisture is present in the cavity portion.

33. The cable moisture detector of claim 19, wherein the moisture engagement portion comprises a moisture expansion portion that is configured to expand when moisture engages the moisture expansion portion so as to cause the moisture detection signal to generate the generate the moisture detected signal when moisture is present in the cavity portion.

34. The cable moisture detector of claim 33, wherein the moisture expansion portion comprises a moisture expanding material that is configured to expand when moisture engages the moisture expanding material.

35. The cable moisture detector of claim 19, wherein a piston portion is configured to disposed in at least a portion of the cable cavity portion so as to move in at least a portion of the cable cavity portion when the moisture engaging portion when moisture engages the moisture detection portion so as to cause the moisture detection signal to generate the generate the moisture detected signal when moisture is present in the cable cavity portion.

36. The cable moisture detector of claim 19, wherein the moisture detection portion further comprises a moisture-soluble material disposed on at least a portion of a surface portion of an outer cable conductor portion, and a moisture engaging portion configured to be engage the moisture detection portion and the moisture-soluble material, and wherein when moisture is present in the cavity, the moisture-soluble material is configured to dissolve so as to cause the moisture engaging portion to engage the outer cable conductor portion and cause the moisture detection portion to generate the generate the moisture detected signal.

37. The cable moisture detector of claim 19, wherein the moisture engaging portion comprises a moisture contact portion and the moisture-soluble material is configured to dissolve so as to cause the moisture contact portion to contact the outer cable conductor portion and cause the moisture detection portion to generate the generate the moisture detected signal.

38. The cable moisture detector of claim 19, further comprising a holding portion disposed in at least a portion of the cable cavity portion and configured to hold the inner cable conductor in at least a portion of the cable cavity portion.
